(19) United States
(12) Patent Application Publication
(10) Pub. No.: US 2005/0086542 A1
(43) Pub. Date: Apr. 21, 2005

(54) Authentication system

(75) Inventors: Yuichi Nakazawa, Yamatokoriyama-shi (JP); Makoto Fujishima, Yamatokoriyama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MORI SEIKI CO., LTD., Yamatokoriyama-shi (JP)

(21) Appl. No.: 10/947,203

(22) Filed: Sep. 23, 2004

(30) Foreign Application Priority Data
Sep. 30, 2003 (JP) 2003-340541

(51) Int. Cl. H04L 9/32

(52) U.S. Cl. 713/202

(57) ABSTRACT

An authentication system includes a mail server (11) which receives an electronic mail delivered from a customer's machine tool (20), an operation state database (12) which stores operation state data extracted from the received electronic mail, a web server (13) which transmits specific operation state data to a customer's user PC (21) from the operation state database (12), a general identification database (14) in which general user IDs and passwords for identification of customers and machine codes of customers' machine tools (20) associated with the general user IDs are registered, a private server (15) which is accessible only by a service center PC (17) via a virtual private network, and a special identification database (16) in which special user identification data for identification of a service person and machine codes of all the customers' machine tools associated with a special user ID are registered.

### BACKGROUND OF THE INVENTION

1. Field of the Invention

The present invention relates to an authentication system for user authentication in a network system in which a server provides various services via a network.

2. Description of Related Art

In recent years, a variety of network systems have been constructed, which permit users to access web servers via the Internet and utilize various services provided by the web servers. A machine tool operation state management system has been proposed as one of these network systems (see, for example, Japanese Unexamined Patent Publications No. 5-333775 (1993), No. 2003-167851, No. 2002-229952).

In the machine tool operation state management system, a machine tool maker centrally manages information related to the operation states of machine tools sold to customers, and provides the information to the customers whenever the customers require it. Data of the operation states (hereinafter referred to as “operation state data”) of the machine tools owned by the customers is collected via the Internet and accumulated by the machine tool maker.

When a customer wants to browse or acquire the operation state data of a machine tool owned by itself, the customer accesses a web server provided by the machine tool maker via the Internet. At this time, it is necessary to prohibit the customer from browsing or acquiring operation state data of machine tools owned by the other customers. To this end, the machine tool operation state management system employs an authentication system having, for example, the following construction.

The authentication system includes an identification database in which user identification data entities such as user IDs and passwords for identification of the respective customers and machine codes of machine tools associated with the user identification data entities are registered for the respective customers, and an operation state database which stores the operation state data of the respective machine tools in association with the respective machine codes. If identification data inputted by a customer for access to the web server matches any of the user identification data entities registered in the identification database, the authentication system permits the customer to browse and acquire operation state data of machine tools specified by machine codes associated with the matched user identification data entity out of the operation state data stored in the operation state database.

In the machine tool operation state management system, a service person in a service center of the machine tool maker is also permitted to utilize the machine tool operation state data stored in the operation state database for maintenance and trouble-shooting of the customers' machine tools. The service person is assigned special user identification data (a special user ID and a password) thereby to be authorized to browse the operation state data of all the customers' machine tools.

The machine codes of all the customers' machine tools are preliminarily registered in association with the special user identification data in the identification database in which the user identification data entities for the respective customers are also registered. Like the customers, the service person accesses the web server from a personal computer provided in the service center via the Internet to browse necessary operation state data of a customer's machine tool.

In the aforesaid authentication system, the special user identification data for the service person is registered in the same identification database as the user identification data entities for the customers, and the service person accesses the web server via the Internet for browsing the operation state data of the customers' machine tools. However, if any of third parties including the customers illegally acquires the special user identification data, there is a risk that the operation state data of all the customers' machine tools stored in the operation state database could be leaked to the third party, because it is impossible to prohibit the third party from accessing the web server.

It is therefore an object of the present invention to provide an authentication system which prevents the leak of the accumulated data to the third party even if the third party illegally acquires the special user identification data.

### SUMMARY OF THE INVENTION

According to the present invention to achieve the aforesaid object, there is provided an authentication system comprising: a general identification database in which general user identification data entities for identification of authentic general users and codes associated with the general user identification data entities are registered for the respective general users; an information database which stores predetermined information for the respective codes; a general server which is accessible via a network; a private server which is accessible only by an authentic special user; and a special identification database in which special user identification data for identification of the authentic special user and codes associated with some or all of the general user identification data entities are registered, the codes being also associated with the special user identification data; wherein, if identification data inputted by a general user for access to the general server matches any of the user identification data entities registered in the general user identification database, the inputting general user is permitted to acquire information for a code associated with the matched general user identification data entity from the information stored in the information database; wherein, if identification data inputted by the special user for access to the private server matches the special user identification data registered in the special user identification database, the inputting special user is permitted to acquire information for the codes associated with the special user identification data from the information stored in the information database.

In the authentication system, the codes associated with all the general user identification data entities are registered in association with the special user identification data in the special identification database and, when a new code is registered in the general identification database, the new code is also registered in association with the special user identification data in the special identification database.

In the inventive authentication system, only the authentic special user is permitted to access the private server for browsing the information related to some or all of the general users. The special user identification data assigned to the special user is registered in the special identification database provided separately from the general identification database in which the general user identification data entities assigned to the respective general users are registered. The authentication of the special user is performed by comparing the identification data inputted by the special user for accessing the private server with the special user identification data registered in the special identification database. Even if any of third parties including the general users illegally obtains the special user identification data, the third party cannot access the private server. Therefore, the third party is not authenticated as the special user. Hence, the information stored in the information database is not leaked to the third party, as long as the third party accesses the general server via the network.

When the new code is registered in the general identification database, the new code is also registered in association with the special user identification data in the special identification database. Therefore, the special user is assuredly permitted to acquire the information stored for all the users in the information database at this time point.

The foregoing and other objects, features and effects of the present invention will become more apparent from the following description of the preferred embodiments with reference to the attached drawings.

### BRIEF DESCRIPTION OF THE DRAWING

FIG. 1 is a schematic diagram illustrating the construction of a machine tool operation state management system which employs an authentication system according to the present invention.

### DESCRIPTION OF THE PREFERRED EMBODIMENT

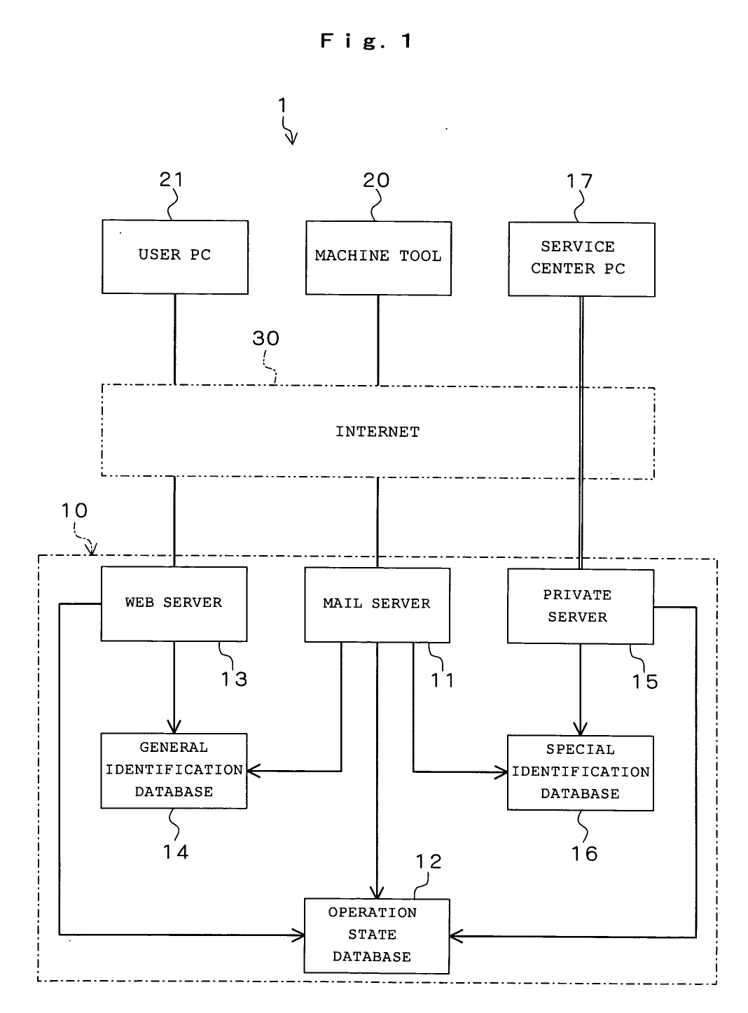

An embodiment of the present invention will hereinafter be described with reference to the attached drawing. FIG. 1 illustrates a machine tool operation state management system 1 in which a machine tool maker centrally manages information related to the operation states of machine tools sold to customers, and provides the information to the customers whenever the customers require it. A service person in a service center of the machine tool maker is permitted to utilize the information managed by the operation state management system 1 for maintenance and trouble-shooting of the customers' machine tools.

In the machine tool operation state management system 1, as shown in FIG. 1, a machine tool 20 and a personal computer (hereinafter referred to as “user PC”) 21 owned by each of the customers are connected to an operation state management apparatus 10 provided in the service center via the Internet 30. Operation state data is automatically collected from the customer's machine tool 20 by a data collector not shown. The collected operation state data of the machine tool 20 together with a general user ID indicating the identity of the customer and a machine code indicating the identity of the machine tool are periodically transmitted in the form of an electronic mail to the operation state management apparatus 10, and accumulated in the operation state management apparatus 10.

As shown in FIG. 1, the operation state management apparatus 10 includes a mail server 11 connected to the Internet 30 for receiving the electronic mail transmitted from the customer's machine tool 20, an operation state database 12 which stores the operation state data extracted from the electronic mail received by the mail server 11, and a web server 13 connected to the Internet 30 for transmitting specific operation state data to the customer's user PC 21 from the operation state database 12. When the customer wants to know the operation state of the customer's machine tool 20, the customer accesses the web server 13 via the Internet 30.

In the machine tool operation state management system 1, it is necessary to permit an authentic customer to acquire only the operation state data of the customer's machine tool 20 when the customer requests the information. In other words, it is necessary to prevent the operation state data of the customer's machine tool 20 from leaking to a third party other than the customer. To this end, the operation state management apparatus 10 includes an authentication system which includes a general identification database 14 in which general user identification data entities such as general user IDs and passwords for identification of the customers and machine codes of the customers' machine tools 20 associated with the general user IDs are registered. With this arrangement, if identification data inputted by the customer through the user PC 21 for access to the web server 13 matches any of the general user identification data entities registered in the general identification database 14, the authentication system authenticates the customer as an authentic customer, and then permits the web server 13 to transmit the operation state data of the machine tool 20 specified by the machine code associated with the customer's general user ID to the user PC 21.

In the machine tool operation state management system 1, the service person in the service center is authorized to browse all the machine tool operation state data stored in the operation state database 12 so as to utilize the machine tool operation state data for maintenance and trouble-shooting of the customers' machine tools 20. Therefore, the service person is assigned special user identification data such as a special user ID and a password.

However, where the special user identification data for the service person is registered together with the general user identification data entities for the customers in the general identification database 14, the operation state data of all the customers' machine tools 20 would leak to any of third parties (including the authentic customers) which illegally obtains the special user identification data, because it is impossible to prohibit the third parties to access the web server 13.

Therefore, the authentication system employed in the machine tool operation state management system 1 further includes a private server 15 provided separately from the web server 13 (connected to the Internet 30) and connected only to a personal computer (hereinafter referred to as “service center PC”) 17 provided in the service center via a virtual private network (VPN), and a special identification database 16 in which the special user identification data is registered and the machine codes of all the customers' machine tools registered in the general identification database 14 are registered in association with the special user ID. With this arrangement, if identification data inputted by the service person through the service center PC 17 for access to the private server 15 matches the special user identification data registered in the special identification database 16, the authentication system authenticates the service person as the authentic service person, and then permits the private server 15 to transmit the operation state data of the machine tools 20 specified by the machine codes associated with the special user ID, i.e., the operation state data of all the customers' machine tools 20, to the service center PC 17.

When an electronic mail containing operation state data of a new machine tool not registered in the general identification database 14 is delivered to the mail server 11 in the machine tool operation state management system 1, it is necessary to store the operation state data in the operation state database 12 and to store the machine code of the new machine tool in the general identification database 14. Therefore, whenever the mail server 11 receives an electronic mail, the mail server 11 compares a machine code contained in the electronic mail with the machine codes stored in the general identification database 14. If the machine code contained in the electronic mail does not match any of the machine codes registered in the general identification database 14, the machine code is stored in the general identification database 14, and stored in association with the special user ID in the special identification database 16. Thus, the service person is assuredly permitted to browse all the operation state data stored in the operation state database 12 at this time point.

In the authentic system employed in the machine tool operation state management system 1, as described above, the private server 15 accessible only by the service center PC 17 operated by the service person and the special identification database 16 in which the special user identification data assigned to the service person is registered are provided separately from the web server 13 freely accessible by the customers' PCs 21 via the Internet 30 and the general identification database 14 in which the general user identification data entities assigned to the respective customers are registered. Further, the service center PC 17 and the private server 15 are connected to each other via the Internet through the virtual private network (VPN) which provides a higher level of security. Even if any of the third parties including the authentic customers illegally obtains the special user identification data, the third party cannot access the private server 15. Therefore, the third party is never authenticated as the authentic service person. As long as the third party accesses the web server 13 via the Internet 30, the operation state data stored in the operation state database 12 is not leaked to the third party.

In the aforesaid embodiment, the service center PC 17 and the private server 15 are connected to each other via the virtual private network (VPN). However, the connection between the service center PC 17 and the private server 15 may be achieved by any other private line which provides a higher level of security.

In the aforesaid embodiment, the service person is permitted to browse all of the operation state data stored in the operation state database 12. However, the service person may be prohibited from browsing the operation state data of some of the customers' machine tools 20. Even in this case, the inventive authentication system is effective.

In the aforesaid embodiment, the general user IDs (special user ID) and the passwords are used as the general user identification data (special user identification data). Alternatively, any of various other data may be used as the user identification data, as long as the user identification is possible.

In the aforesaid embodiment, the machine tool operation state management system is designed such that the operation state data and the like are delivered in the form of the electronic mail. The inventive authentication system is also applicable to a machine tool operation state management system designed such that the machine tool 20 is connected to the operation state management apparatus 10 via the Internet 30 and the operation state data is transmitted directly to the operation state management apparatus 10 from the machine tool 20.

The aforesaid embodiment is directed to the authentication system employed in the machine tool operation state management system 1. The present invention is applicable to any authentication systems which include an identification database in which user identification data entities and predetermined codes associated with the user identification data entities are registered, an information database which stores predetermined information in association with the codes, and a server such as a web server accessible via any of various network systems including the Internet, and permits a user to acquire the predetermined information by accessing the server via the network.

While the present invention has been described in detail by way of the embodiment thereof, it should be understood that the foregoing disclosure is merely illustrative of the technical principles of the present invention but not limitative of the same. The spirit and scope of the present invention are to be limited only by the appended claims.

1. An authentication system comprising:
a general identification database in which general user identification data entities for identification of authentic general users and codes associated with the general user identification data entities are registered for the respective general users;
an information database which stores predetermined information for the respective codes;
a general server which is accessible via a network;
a private server which is accessible only by an authentic special user; and
a special identification database in which special user identification data for identification of the authentic special user and codes associated with some or all of the general user identification data entities are registered, the codes being also associated with the special user identification data;
wherein, if identification data inputted by a general user for access to the general server matches any of the user identification data entities registered in the general user identification database, the inputting general user is permitted to acquire information for a code associated with the matched general user identification data entity from the information stored in the information database;
wherein, if identification data inputted by the special user for access to the private server matches the special user identification data registered in the special user identification database, the inputting special user is permitted to acquire information for the codes associated with the special user identification data from the information stored in the information database.

2. An authentication system as set forth in claim 1,
wherein the codes associated with all the general user identification data entities are registered in association with the special user identification data in the special identification database,
wherein, when a new code is registered in the general identification database, the new code is also registered in association with the special user identification data in the special identification database.
